(19) United States
(12) Patent Application Publication
(10) Pub. No.: US 2026/0301983 A1
(43) Pub. Date: Oct. 1, 2026

(54) LASER ABLATION DECONTAMINATION SYSTEM AND METHOD OF USING SAME

(71) Applicant: CANDU ENERGY INC., Mississauga (CA)

(72) Inventors: Miroljub PETROVIC, Dundas (CA); Tiberiu TEODORESCU, Mississauga (CA); Nathan KOTEY, Brampton (CA); Tim CAMPAGNA, Mississauga (CA)

(21) Appl. No.: 19/489,809

(22) PCT Filed: Jun. 4, 2024
(86) PCT No.: PCT/CA2024/050750

§ 371 Date: Dec. 3, 2025

Related U.S. Application Data
(60) Provisional application No. 63/521,498, filed on Jun. 16, 2023.

(51) Int. Cl. G21F 9/00; B08B 7/00; B08B 15/00; G21F 9/02

(52) U.S. Cl. CPC G21F 9/005; B08B 7/0042; B08B 15/00; G21F 9/02; B08B 2215/003

(57) ABSTRACT

Systems and methods for decontaminating a surface comprising radioactive contamination are provided. The system comprises an ablation chamber which includes a body defining a receptacle for receiving a laser head and an opening for positioning over the surface. The receptacle and the laser head are configured to direct a laser to the surface and to ablate the radioactive contamination into ablation products. A support may position the body above the surface and define a gap between the body and the surface. A suction blower is in fluid communication with the ablation chamber and is configured to provide a vacuum within the ablation chamber to move the ablation products from the ablation chamber to a filtration system. The filtration system filters the particles from air as it moves from the ablation chamber to the outlet.

### CROSS REFERENCE TO RELATED APPLICATION AND CLAIM OF PRIORITY

The present application claims priority to U.S. provisional patent application no. 63/521,498 filed on Jun. 16, 2023, the entire contents of which are hereby incorporated by reference.

### TECHNICAL FIELD

The disclosure relates generally to radioactive decontamination, and more particularly to laser ablation decontamination systems and methods.

### BACKGROUND

Low-Level Radioactive Waste (LLW) includes contaminated with radioactive material or have become radioactive through exposure to neutron radiation. LLW may include shoe covers, clothing, wipes, filters, tools, etc. Low-level waste may be stored at a nuclear generation facility, either until it has decayed away and can be disposed of as ordinary trash, or until amounts are large enough for shipment to a low-level waste disposal site in containers approved by regulators such as the U.S. Department of Transportation or the Canadian Nuclear Safety Commission Transportation. Storage and transportation of LLW is expensive, requires monitoring and testing of the LLW, and is a safety risk due to potential exposures of personal who have to move or work near the LLW.

### SUMMARY

Systems and methods for treating LLW to remove radioactive contamination are described in this disclosure.

In one aspect, the disclosure describes a system for decontaminating a surface comprising radioactive contamination. The system comprises: an ablation chamber comprising: a body defining a receptacle for receiving a laser head and an opening for positioning over the surface, the receptacle and the laser head configured to direct a laser to the surface and to ablate the radioactive contamination into particles dispersed in air. The ablation chamber may also comprise a support for positioning the body above the surface and to define a gap between the body and the surface. A suction blower may be in fluid communication with the ablation chamber. The suction blower may be configured to force air external to the ablation chamber into enter the ablation chamber, collect the ablation products (e.g. aerosol with particles) and transport them to the filtration system. The filtration system may comprise at least one filter, preferably a plurality of filters, configured to filter the particles from air as the air moves to an outlet. When the suction blower is in operation, a flow path is defined by an exterior of the ablation chamber, the opening, an interior of the ablation chamber, the filtration system, and the outlet.

In an embodiment, the outlet is a ventilation system.

In an embodiment, the system comprises a laser unit comprising the laser head for directing the laser to the surface and to ablate the radioactive contamination into the particles. In an example, the laser has at least a 500 W laser power.

In an embodiment, the receptacle is configured to pivot to adjust the focal length of the laser head. In another embodiment, receptacle is configured to pivot the laser head in a range of about 5 -25 degrees relative to a longitudinal axis of the ablation chamber, preferably the receptacle is configured to pivot the laser head in a range of 20 degrees relative to the longitudinal axis of the ablation chamber.

In an embodiment, the ablation chamber and the opening are configured to adjust focal length to between 56 cm and 61 cm.

In an embodiment, the support is a plurality of rollers.

In an embodiment, the ablation chamber has a circular horizontal cross-section for creating a vortex. In another embodiment, the ablation chamber comprises a plurality of passages fluidly communicating the exterior of the ablation chamber with the interior of the ablation chamber, the plurality of passages position around a circumference of the ablation chamber.

In an embodiment, the filtration system comprises at least one of a pre-filter, a High Efficiency Particulate Air (HEPA) filter, a Ultra-Low Particulate Air (ULPA) filter; and a magnetic collection system comprising magnets for collecting ferrous metals in the particles. In another embodiment, the system comprises a pre-filter for collecting a portion of the particles having a size of about at least 0.3 microns. In an embodiment, the system comprises the HEPA filter, the ULPA filter; and the magnetic collection system positioned in series. In another embodiment, the pre-filter, the HEPA filter, the ULPA filter; and the magnetic collection system are cartridges configured to be removed from the filtration system. In another embodiment, the HEPA filter, the UPLA filter, and the magnetic collection system are configured to collect a portion of the particles having a size of about at least 0.12-microns.

Embodiments may include combinations of the above features.

In another aspect, the disclosure describes a method for decontaminating a surface comprising radioactive contamination. The method comprises: positioning an ablation chamber on the surface, the ablation chamber comprising a body defining a receptacle for receiving a laser head and an opening for positioning over the surface. The laser head may be configured to direct a laser to the surface and to ablate the radioactive contamination into ablation products, e.g. particles dispersed in air as an aerosol. The method also comprises: laser ablating the surface to create the ablation products (e.g. aerosol with particles); suctioning the ablation products from the ablation chamber to a filtration system; filtering the particles from the air with the filtration system; and discharging the air.

In an embodiment, the method comprises forming a vortex in the ablation chamber to lift the particles from the surface.

In an embodiment, the method comprises rolling the ablation chamber over the surface while laser ablating the surface.

In an embodiment, the method comprises pivoting the angle of the laser ablating the surface in a range of about 5 -25 degree angle relative to a longitudinal axis of the ablation chamber, preferably at a 20 degree angle relative to the longitudinal axis and 70 degree relative to the ablated surface.

In an embodiment, the method comprises adjusting the focal length of the laser head to between 56 cm and 61 cm.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 shows an elevation view of an example system for decontaminating a surface comprising radioactive contamination;

FIG. 2a is perspective view of an example ablation chamber for the system shown in FIG. 1; and

FIG. 2b is perspective view of the example ablation chamber of FIG. 2a showing internal portions of the ablation chamber in stippled lines.

FIG. 3 is flow diagram of an exemplary method for decontaminating a surface comprising radioactive contamination.

### DETAILED DESCRIPTION

Laser ablation techniques for decontamination in the nuclear sector have not previously been extensively explored. Laster ablation may be used to remove surface layer contamination from metal surfaces by pulverization. Example trial applications performed to date show over 90% efficiency in radioactive contamination removal from metallic Low-Level Waste (LLW). In contrast to alternative methods (e.g., sand blasting, grinding etc.), laser ablation creates minimal amount of secondary waste. More specifically, laser ablation creates secondary waste in the form of particles dispersed in fumes as a aerosol. Previous attempts at using laser ablation decontamination under a fume hood achieved removal of radioactive contamination; however, the challenge exists in containment and filtration of the ablation products (secondary waste) to minimize the exposure of workers and the surrounding environment to radioactive particulate. System and methods according to this disclosure may address these challenges in commercially efficient way(s).

Moreover, there is a significant need for processing LLW. The systems of methods according to this disclosure may reduce the amount of LLW that needs to be stored and/or transported to an LLW storage site.

### Definitions

Although terms such as “maximize”, “minimize” and “optimize” may be used in the present disclosure, it should be understood that such term may be used to refer to improvements, tuning and refinements which may not be strictly limited to maximal, minimal or optimal.

The term “connected” or “coupled to” may include both direct coupling (in which two elements that are coupled to each other contact each other) and indirect coupling (in which at least one additional element is located between the two elements).

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

Laser ablation of a surface reduces the amount of secondary waste as a laser is used to pulverize a contaminated surface rather that a purely physical substance, (e.g. blasted sand and/or water, or a metal grinder). A challenge with laser ablation is to contain the ablation area to allow air ingress from surrounding environment over ablation site while preventing ablated particles from escaping to surrounding environment. This may be achieved by the systems and method according to this disclosure, which may include:
1. A movable ablation chamber/suction hood that integrate a laser head;
2. A filtration system with High Efficiency Particulate Air (HEPA) and/or Ultra-Low Particulate Air (ULPA) cartridge; and
3. A magnetic collection system for particles not retained by HEPA/ULPA filter.

Aspects of various embodiments are described through reference to the drawings.

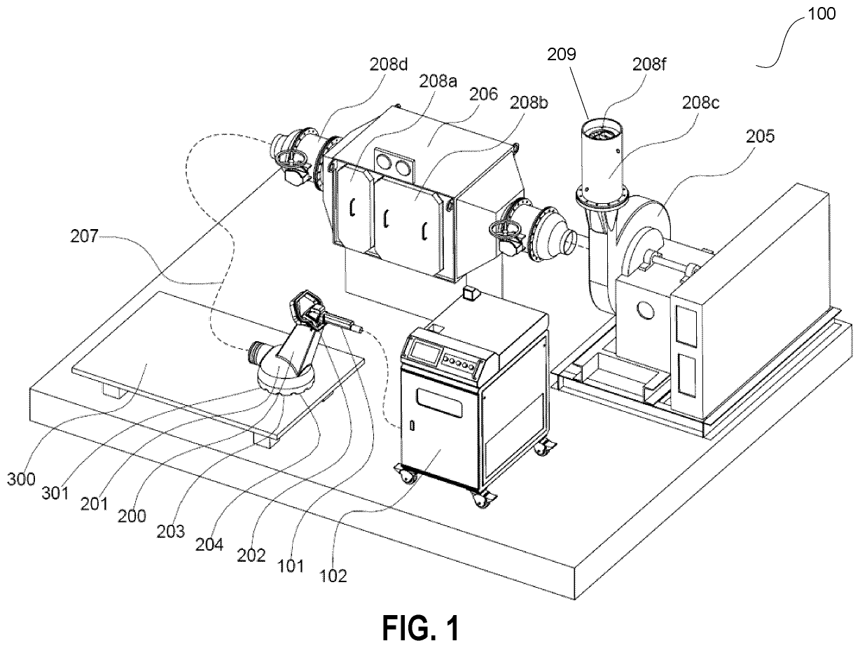

FIG. 1 illustrates an example system 100 for decontaminating a surface 300 comprising radioactive contamination according to this disclosure. System 100 comprises an ablation chamber 200. Ablation chamber 200 may comprise a body 201 defining a receptacle 202 for receiving a laser head 101 and an opening 203 for positioning over surface 300. Receptacle 202 and the laser head 101 may be configured to direct a laser 101a from the laser head to surface 300 to ablate the radioactive contamination on surface 300 into particles dispersed in air. Ablation chamber 200 may comprise a support 204 for positioning body 201 above surface 300 and to define a gap 301 between the body 201 and surface 300. During operation, pressure within ablation chamber 200 may decrease as suction pulls air from the ablation chamber 200 and air may be suctioned through gap 301. To create a vacuum within ablation chamber 200, a suction blower 205 may be provided in fluid communication with ablation chamber 200. Suction blower 205 may be configured to provide a vacuum within the ablation chamber such that ablation products generated from ablation of surface 300 may be moved from ablation chamber 200 to filtration system 206. As shown in FIG. 1, body 201 of ablation chamber 200 is in fluid communication with filtration system 206 via hose 207. Filtration system 206 may comprise at least one filter 208a, 208b, 208c configured to filter the particles from air as the air moves from filters 208a-208c to an outlet 209. In an embodiment, outlet 209 may be a ventilation system of a building, e.g. a nuclear energy production facility. When the suction blower 205 is in operation, a flow path is defined by an exterior of the ablation chamber 200, opening 203, an interior of the ablation chamber 201, filtration system 206, and outlet 209.

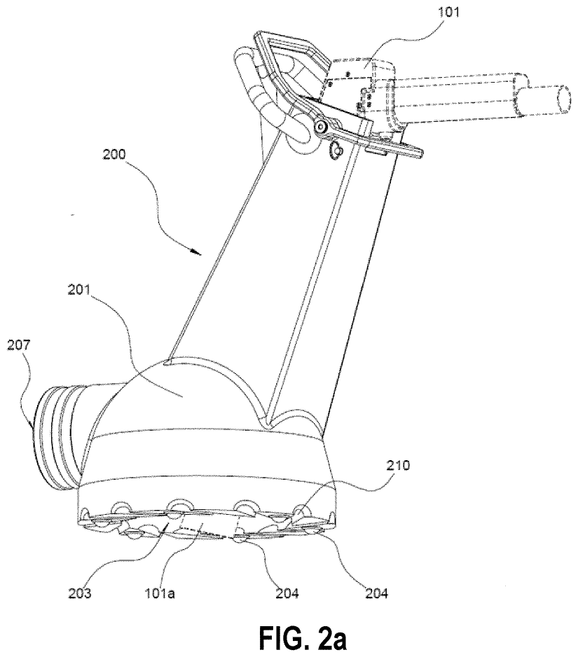

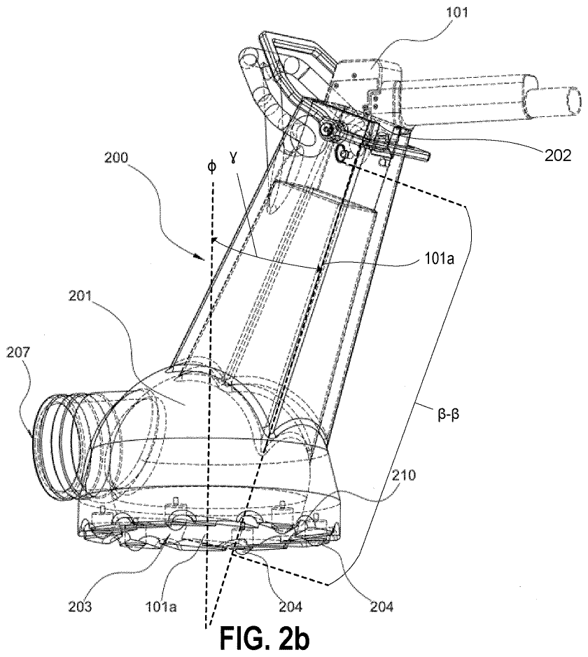

Ablation chamber 200 (also referred to in this disclosure as a suction hood) may be designed to prevent ablated particles from escaping to the surrounding environment. The shape and interior chamber defined by body 201 of ablation chamber 200 may be configured to prevent ablated radioactive particles to be ejected to the environment exterior to ablation chamber 200 while allowing outside air to enter body 201 of ablation chamber 200, cool down ablated particles, and lift the ablated particles to filtration system 206. In an embodiment, ablation chamber 200 may comprise a plurality of passages 210 that may create cyclone (vortex) effect and lift the ablated particles to hose 207 and filtration system 206. In an embodiment, ablation chamber 200 comprises a plurality of passages 210 fluidly communicating the exterior of the ablation chamber 200 with the interior of the ablation chamber 200, the plurality of passages positioned around a circumference of the ablation chamber 200. As shown in FIGS. 2a and 2b, ablation chamber 200 may also have a circular horizontal cross-section for creating a cyclone (vortex) within chamber 200 during operation as air is drawn through at least one of opening 203 and/or passages 210.

In an embodiment, ablation chamber 200 has a receptacle 202 which receives a laser head 101. Receptacle 202 may comprise an opening defined by ablation chamber 200 to allow a laser from laser head 101 ablate surface 300 such that a layer of the surface comprising radioactive contamination is turned into particles which may be dispersed as an aerosol. Receptacle 202 may be configured accept laser head 101 to pivot at an angle [symbol] such that a laser from laser head 101 may abate any portion of surface 300 defined by the circumference of opening 203. As shown in FIG. 2b, in an example, receptacle may be configured such that laser head may pivot in a range of 5 -25 degree angle [symbol] relative to a longitudinal axis φ of ablation chamber and/or adjust a focal length β-β of the laser to for example between 56 cm and 61 cm in ablation chamber 200 by moving the laser head 101 toward or away from surface 300. In an embodiment the laser head may pivot in at a 20 degree angle [symbol] relative to a longitudinal axis φ of ablation chamber. In another embodiment, laser head 101 may be coupled to ablation chamber by telescoping member configured to allow laser head 101, to move toward or away from surface 300.

Laser head 101 may be part of a commercial available laser unit 102, e.g. LaserClean™ DCL-3000. In an example, laser head 101 may output a laser having a power output of at least 500 W. In another example, laser head 101 may have an output of at least a 1000 W.

Ablation chamber 200 may be provided with a support 204 for positioning body 201 above surface 300 and to define gap 301 between the portion of body 201 defining opening 203 and surface 300. Support 204 may comprise at least one roller positioned to support ablation chamber 200 on surface 300. The at least one roller may allow the position of the ablation chamber 200 to be adjusted/moved with respect to surface 300. Movement of ablation chamber 200 over surface 300 may allow continuous operation of the laser of laser head 101 for cleaning contaminated portions of surface 300. Support 203 may also be adjusted such that the size of gap 301 above surface 300 may be modified and to adjust the distance of the laser head above surface 300. In an example, support 203 and ablation chamber are configured to position the laser head 101 in a range of 20-100 cm above surface 300, preferably in a range of 55-61 cm above surface 300. In another example, support 203 may position body 201 of ablation chamber in a range of 1 mm to 5 cm above surface 300.

As shown in FIG. 1, filtration system 206 may be positioned in series and upstream to suction blower 205. In an example, suction blower 205 may be a blower having at least a 1500 scfm flow capacity and may have about 30 inWG external static pressure. Suction blower 205 may be positioned in the flow path between the ablation point and the output 209 which in some embodiments may be an active ventilation system. Suction blower 205 may provide a pressure differential, e.g. vacuum downstream of ablation chamber 200, to move air and collected ablated particles to filtration system 206. Filtration system 206 may comprise a blower, pre-filter 208d, a High Efficiency Particulate Air (HEPA) filter 208a, a Ultra-Low Particulate Air (ULPA) filter 208b, and/or a magnetic collection system 208c. The HEPA, ULPA, and magnetic collection systems may each comprise cartridges to permit installation and removal of each of the filters for disposal as low-level waste (LLW). Each cartridge may be installed via a flanged insert. Each cartridge may comprise a seal such that when installed the cartridges do not permit external air into filtration system 206. In an example, pre-filer 208d may have an efficiency of 95% per ASHRAE 52.2, HEPA filter 208a may have at least a 99.97% efficiency for filtering 0.3-micron particles or greater; and/or ULPA filter 208b may have at least a 99.999% efficiency for filtering 0.12-micron particles or greater. The magnetic collection system 208c may comprise at least one inline magnet. In an example, the magnetic collection system 208c may be positioned in series and downstream of pre-filter 208d, HEPA filter 208a, and ULPA filter 208b. In an embodiment, the pre-filter, HEPA, ULPA and magnetic collection system may be upstream of outlet 209 e.g. an active ventilation connection point. Magnets of the magnetic collection system 208c may produce extremely high fields, e.g. at least 10,000 Gauss, to attract and collect particles from the aerosol that are not retained by the pre-filter, HEPA, and/or ULPA filters. Particles comprising radioactive contamination may be firmly attached to a filter 208c, f of the magnetic collection system by magnetic force. Filter 208c, f may be removed and bagged as a LLW, e.g. when radiation survey determines requirement for a replacement filter.

In an embodiment, filtration system 206 may comprise a pre-filter 208d which may be positioned in series and upstream of HEPA filter 208a, ULPA filter 208b, and magnetic collection system 208c to filter larger particles, i.e. coarser particles, before those particles would reach filters 208a-c. In an example, pre-filter 208d may be configured to provide a 99.97% efficiency for 0.3-micron particles and may also catch larger particles than 0.3 microns. By pre-filtering the larger/coarser particles in advance, pressure drop can be minimizes and filtering efficiency for collecting finer particles can be maximized across HEPA filter 208a, ULPA filter 208b, and magnetic collection system 208c.

System 100 may be made from material suitable for exposure to radioactive contaminated material. In an non-limiting example, filters 208a-d may be made from metal(s) such as aluminum (e.g. 1145 aluminum), and/or galvannealed steal. Sealant material may be fire retardant, phosphorous free two-part polyurethane; and gaskets may be made from neoprene. Each component of system 100 may chemically stable at least up to 200 deg C. Similarly, laser head 101 and associated cable coupling to laser head 101 to laser unit 102 may be made material suitable for exposure to radioactive contaminated material. Notably, systems for decontaminating a surface according to this disclosure do not expose laser unit 102 to radioactive contaminated material; accordingly, laser unit 102 may be reused and/or handled as non-contaminated material.

Filtration system 206 may also comprise control instrumentation such as pressure gauges, flow meter, temperature sensors, etc.

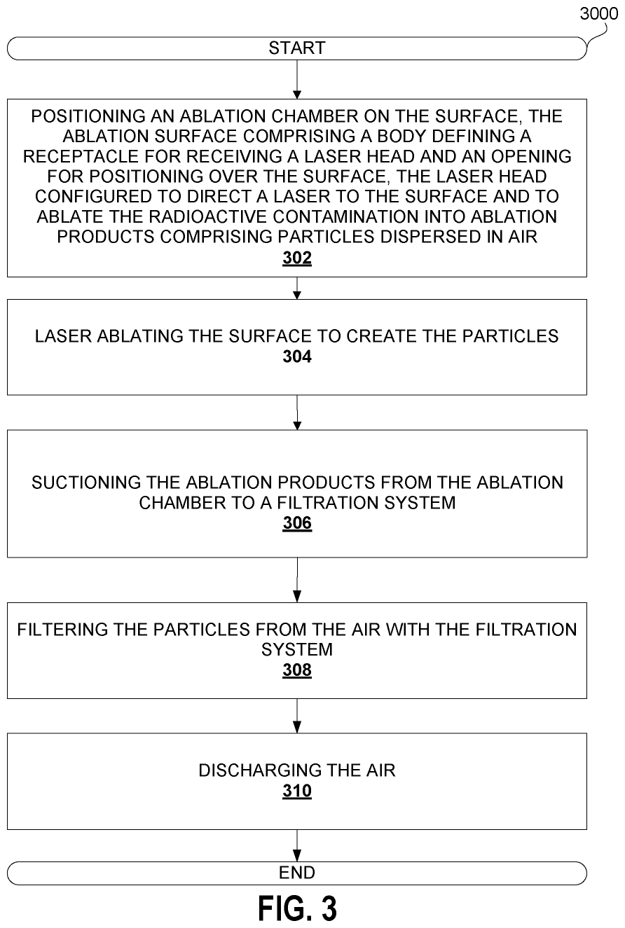

FIG. 3 is a flow diagram of an exemplary method 3000 for decontaminating a surface comprising radioactive contamination. Method 3000 may be performed using system 100 described herein or using other system(s). It is understood that aspects of method 3000 may be combined with aspects of other methods described herein. In various embodiments, method 3000 may include, at block 302 positioning an ablation chamber on a surface to be ablated. The surface may be a flat surface as shown in FIG. 1. Ablation chamber, e.g. ablation chamber 200, may comprise a body defining a receptacle for receiving a laser head and an opening for positioning over the surface, the laser head configured to direct a laser to the surface and to ablate the radioactive contamination into particles dispersed in air as an aerosol. In an embodiment, the ablation chamber is rolled to a desired position on top of the surface. The ablation chamber may be moved to the desired position before or during laser ablation of the surface at block 304.

At block 304, the surface may be laser ablated to create the particles which may form an aerosol. In an example, the laser ablating the surface is at least a 500 W laser. In another example, the laser is at least a 1000 W laser. In embodiment, the laser ablating the surface is at an angle in a range of 50-25 degree relative to a longitudinal axis of the ablation chamber. In another embodiment, the laser ablation the surface is at a 20 degree angle relative to a longitudinal axis of the ablation chamber and 70 degree relative to ablated surface.

At block 306, the aerosol comprising the particles may be suctioned from the ablation chamber to a filtration system. In an embodiment, a vortex is formed in the ablation chamber to suction the particles from the surface.

At block 308, the particles may be filtered from the air with the filtration system. The filtration system may comprise filter cartridges, e.g. a pre-filter, HEPA, ULPA, and/or magnetic filter cartridges, which may be removed from the filtration system for disposal of the particles at a LLW facility. The pre-filter, HEPA filter, ULPA filter, and magnetic collection system of the filtration system may be position in series for filtering particles from air, removing smaller particles at each successive filter.

At block 310, the air may be discharged, e.g. to a ventilation system or the atmosphere.

### Alternate Embodiments

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

As can be understood, the detailed embodiments described above and illustrated are intended to be examples only. The invention is defined by the appended claims.

The claims are not intended to include, and should not be interpreted to include, means-plus- or step-plus-function limitations, unless such a limitation is explicitly recited in a given claim using the phrase(s) “means for” or “step for,” respectively.

1. A system for decontaminating a surface comprising radioactive contamination, the system comprising:
an ablation chamber comprising:
a body defining a receptacle for receiving a laser head and an opening for positioning over the surface, the receptacle and the laser head configured to direct a laser to the surface and to ablate the radioactive contamination into ablation products comprising particles dispersed in air; and
a support for positioning the body above the surface and to define a gap between the body and the surface;
a suction blower in fluid communication with the ablation chamber, the suction blower configured to force air external to the ablation chamber to enter the ablation chamber to move the ablation products from the ablation chamber to a filtration system;
the filtration system comprising a plurality of filters configured to filter the particles from air as the air moves to an outlet;
when the suction blower is in operation, a flow path is defined by an exterior of the ablation chamber, the opening, an interior of the ablation chamber, the filtration system, and the outlet.

2. The system of claim 1, wherein the outlet is a ventilation system.

3. The system of claim 1, comprising a laser unit comprising the laser head for directing the laser to the surface and to ablate the radioactive contamination into the particles.

4. The system of claim 3, wherein the laser has at least a 500 W laser power.

5. The system of claim 1, wherein the receptacle is configured to pivot to adjust the focal length of the laser head.

6. The system of claim 5, wherein the receptacle is configured to pivot the laser head in a range of about 5 -25 degrees relative to a longitudinal axis of the ablation chamber, preferably the receptacle is configured to pivot the laser head in a range of 20 degrees relative to the longitudinal axis of the ablation chamber.

7. The system of claim 1, wherein the ablation chamber and the opening are configured to adjust focal length to between 56 cm and 61 cm.

8. The system of claim 1, wherein the support is a plurality of rollers.

9. The system of claim 1, the ablation chamber has a circular horizontal cross-section for creating a vortex.

10. The system of claim 9, wherein the ablation chamber comprises a plurality of passages fluidly communicating the exterior of the ablation chamber with the interior of the ablation chamber, the plurality of passages position around a circumference of the ablation chamber.

11. The system of any one of claim 1, wherein the filtration system comprises at least one of a pre-filter, a High Efficiency Particulate Air (HEPA) filter, a Ultra-Low Particulate Air (ULPA) filter; and a magnetic collection system comprising magnets for collecting ferrous metals in the particles.

12. The system of claim 11, comprising a pre-filter for collecting a portion of the particles having a size of about at least 0.3 microns.

13. The system of claim 11, comprising the HEPA filter, the ULPA filter; and the magnetic collection system positioned in series.

14. The system of claim 11, wherein the pre-filter, the HEPA filter, the ULPA filter; and the magnetic collection system are cartridges configured to be removed from the filtration system.

15. The system of claim 11, wherein the HEPA filter, the UPLA filter, and the magnetic collection system are configured to collect a portion of the particles having a size of about at least 0.12-microns.

16. A method for decontaminating a surface comprising radioactive contamination, the method comprising:
positioning an ablation chamber on the surface, the ablation chamber comprising a body defining a receptacle for receiving a laser head and an opening for positioning over the surface, the laser head configured to direct a laser to the surface and to ablate the radioactive contamination into ablation products comprising particles dispersed in air;
laser ablating the surface to create the ablation products;
suctioning the ablation products from the ablation chamber to a filtration system;
filtering the particles from the air with the filtration system; and
discharging the air.

17. The method of claim 16, wherein comprising forming a vortex in the ablation chamber to lift the particles from the surface.

18. The method of claim 16, comprising rolling the ablation chamber over the surface while laser ablating the surface.

19. The method of claim 16, comprising pivoting the angle of the laser ablating the surface in a range of about 5 -25 degree angle relative to a longitudinal axis of the ablation chamber, preferably at a 20 degree angle relative to the longitudinal axis and 70 degree relative to the ablated surface.

20. The method of claim 16 comprising adjusting the focal length of the laser head to between 56 cm and 61 cm.
